(19) United States
(12) Patent Application Publication
(10) Pub. No.: US 2013/0137566 A1
(43) Pub. Date: May 30, 2013

(54) NANOPOROUS PHOTOCATALYST HAVING HIGH SPECIFIC SURFACE AREA AND HIGH CRYSTALLINITY AND METHOD FOR PREPARING THE SAME

(71) Applicants: Hae-Jin Kim, Daejeon (KR); Jou-Hahn Lee, Daejeon (KR); Soon-Chang Lee, Daejeon (KR); Hyun-Uk Lee, Chungcheongbuk-do (KR); Won-Ki Hong, Daejeon (KR); Hye-Ran Kim, Daejeon (KR); Jung-Hye Seo, Chungcheongnam-do (KR)

(72) Inventors: Hae-Jin Kim, Daejeon (KR); Jou-Hahn Lee, Daejeon (KR); Soon-Chang Lee, Daejeon (KR); Hyun-Uk Lee, Chungcheongbuk-do (KR); Won-Ki Hong, Daejeon (KR); Hye-Ran Kim, Daejeon (KR); Jung-Hye Seo, Chungcheongnam-do (KR)

(21) Appl. No.: 13/401,716

(22) Filed: Feb. 21, 2012

(30) Foreign Application Priority Data
Nov. 28, 2011 (KR) 10-2011-0124981

(51) Int. Cl. B01J 21/06

(52) U.S. Cl. 502/5; 502/350

(57) ABSTRACT

Disclosed is a nanoporous photocatalyst having a high specific surface area and high crystallinity and a method for preparing the same, capable of preparing nanoporous photocatalysts, which satisfy both of the high specific surface area of 350 m²/g to 650 m²/g and high crystallinity through a simple synthetic scheme, in mass production at a low price. The nanoporous catalyst having a high specific area and high crystallinity includes a plurality of nanopores having an average diameter of about 1 nm to about 3 nm. A micro-framework of the nanoporous photocatalyst has a single crystalline phase of anatase or a bicrystalline phase of anatase and brookite, and a specific surface area of the nanoporous photocatalyst is in a range of about 350 m²/g to 650 m²/g.

### CROSS-REFERENCE TO RELATED APPLICATION

This application claims the benefit under 35 U.S.A. §119 of Korean Patent Application No. 10-2011-0124981, filed on Nov. 28, 2011 in the Korean Intellectual Property Office, the entirety of which is incorporated herein by reference.

### BACKGROUND OF THE INVENTION

1. Field of the Invention

The present invention relates to a nanoporous photocatalyst and a method for preparing the same. In more particular, the present invention relates to a nanoporous photocatalyst and a method for preparing the same, capable of preparing nanoporous photocatalysts, which satisfy both of the high specific surface area and high crystallinity through a simple synthesis scheme, in mass production at a low price.

2. Description of the Related Art

A photocatalyst refers to a catalyst activated by light energy. Since the photocatalyst represents the activity and reaction mechanism at the room temperature, the photocatalyst is distinguished from the general catalyst and can be used in a simple and small-size reactor. When light having a predetermined wavelength is irradiated onto semiconductor oxide, such as TiO₂, electrons (e) excited by the light migrate to a conduction band and holes (h⁺) are created and migrate to a surface of the TiO₂. The holes may react with H₂O or OH⁻ on the surface of the TiO₂, so that OH radicals are generated, and the OH radicals decompose the organic matters adhering to the surface of the TiO₂ by oxidizing the organic matters. The TiO₂ has bandgap energy of about 3.2 eV and it is generally known in the art that light having energy higher than the bandgap energy of the TiO₂ among solar lights has the wavelength of 380 nm or below.

The photocatalyst has been extensively used as an environmental material to remove trace organic matters and bad smells, to restrict carcinogenic substances, to treat waste water or to remove Sox and NOx, and used in the energy field to prepare hydrogen fuel by dissolving water. In addition, the photocatalyst has great potential energy in applications thereof. For instance, the photocatalyst can be used to convert harmful components into useful components as well as to decompose harmful substances.

Regarding the research trend related to a titanium dioxide photocatalyst, it has been recently reported that, in order to increase the specific surface area of titanium dioxide, a nanoporous titanium dioxide is synthesized through several process steps of using titanium isopropoxide and hexylamine as titanium dioxide precursors and reacting with hydrochloric acid (HCL), or mesoporous titanium dioxide is synthesized by oxidizing titanium carbide (TiC) by nitric acid (HNO₃). In order to increase the crystallinity of titanium dioxide particles, an electro-spray method or an aerosol deposition method has been recently attempted. However, the preparation methods not only employ high-price raw materials, but also require several process steps. Accordingly, the preparation cost may be increased.

As the related art, there is Korea Unexamined Patent Publication No. 10-2011-0011973 (published on Feb. 9, 2011). The publication discloses a method for preparing titanium dioxide and a method for manufacturing a dye-sensitized solar cell (DSSC) through the preparation method.

### SUMMARY OF THE INVENTION

An object of the present invention is to provide nanoporous photocatalysts prepared through a synthetic method without acids, bases, or other additives to represent superior crystallinity with a specific surface area in the range of 350 m²/g to 650 m²/g.

Another object of the present invention is to provide a method for preparing nanoporous photocatalysts, which have a high specific surface area and the high crystallinity through a simple synthesis scheme without acids, bases, or other additives, in mass production at a low price.

In order to accomplish the above objects, according to an aspect of the present invention, there is provided a nanoporous catalyst including a plurality of nanopores having an average diameter of about 1 nm to about 3 nm, wherein a micro-framework of the nanoporous catalyst has a single crystalline phase of anatase or a bicrystalline phase of anatase and brookite, and a specific surface area of the nanoporous catalyst is in a range of about 350 m²/g to 650 m²/g.

According to another aspect of the present invention, there is provided a method for preparing a nanoporous photocatalyst having a high specific surface area and a high crystallinity, which includes (a) mixing a titanium precursor and a surfactant with a first solvent and sol-gel reacting a mixture, (b) maturing a reactant, which is subject to the sol-gel reaction, for 15 hours to 25 hours, (c) washing the matured reactant after filtering the matured reactant, (d) obtaining titanium dioxide sediments by primarily drying the reactant at a temperature of about 10° C. to about 40° C., (e) mixing the titanium dioxide sediments in a second solvent, and then performing ultrasonification with respect to a mixture for 10 minutes to 60 minutes, and (f) obtaining titanium dioxide photocatalyst particles by secondarily drying the mixture, which has been subject the ultrasonification, at a temperature of about 10° C. to about 40° C.

As described above, according to the present invention, nanoporous photocatalysts having a specific surface area of 350 m²/g to 650 m²/g can be prepared at a low price in mass production through a simple synthesis scheme without acids, bases, or other additives.

In addition, according to the present invention, nanoporous photocatalysts satisfying a high specific surface area and the high crystallinity can be prepared through sol-gel reaction at a room temperature and the ultrasonification for several tens of minutes without several process steps.

Accordingly, since nanoporous photocatalysts having a high specific surface area and high crystallinity, which is prepared according to the method of the present invention, represents superior photodecomposition effects, the nanoporous photocatalysts can be utilized in not only daily necessaries such as an air cleaner or an anti-bacteria filter, but also a memory device, a logic device, a dye-sensitized solar cell, a gas sensor, a bio-sensor, and a flexible device.

In addition, since nanoporous photocatalysts having a high specific surface area and high crystallinity, which is prepared according to the method of the present invention, represents superior purification ability for organic matters, the nanoporous photocatalysts can be applied to green energy fields such as a solar cell, hydrogen energy, or water purification.

### BRIEF DESCRIPTION OF THE DRAWINGS

FIG. 1 is a process flowchart showing a method for preparing nanoporous photo catalysts having a high specific surface area and the high crystallinity according to an embodiment of the present invention;

FIG. 2 is a schematic view use to explain sol-gel reaction;

FIG. 3 is a photograph of a specimen prepared according to embodiment 1, which is taken by an electron microscope;

FIG. 4 is a graph showing an X-ray diffraction pattern for a specimen prepared according to embodiments 1 to 4;

FIG. 5 is a graph showing an X-ray diffraction pattern for a specimen prepared according to embodiments 1 and 2, and the comparative example 1; and

FIG. 6 is a graph showing the experimental results of an organic matter photo oxidation for specimens prepared according to embodiment 1, and the comparative examples 2 and 3.

### DETAILED DESCRIPTION OF THE INVENTION

Advantages and/or characteristics of the present invention, and methods to accomplish them will be apparently comprehended by those skilled in the art when making reference to embodiments in the following description and accompanying drawings. However, the present invention is not limited to the following embodiments, but various modifications may be realized. The present embodiments are provided to make the disclosure of the present invention perfect and to make those skilled in the art perfectly comprehend the scope of the present invention. The present invention is defined only within the scope of claims. The same reference numerals will be used to refer to the same elements throughout the specification.

Hereinafter, nanoporous photocatalysts having the high specific surface area and high crystallinity and a method for preparing the same according to an exemplary embodiment of the present invention will be described with reference to accompanying drawings.

Preparation of Nanoporous Photocatalyst Having High Specific Surface Area and High Crystallinity

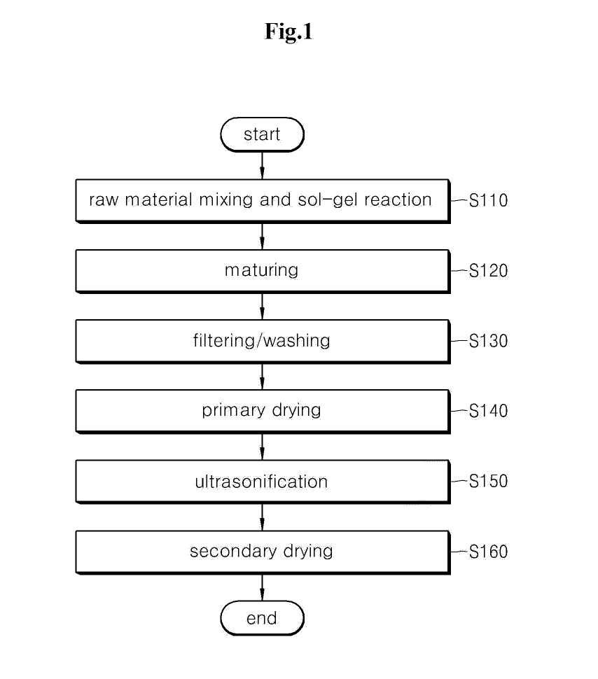

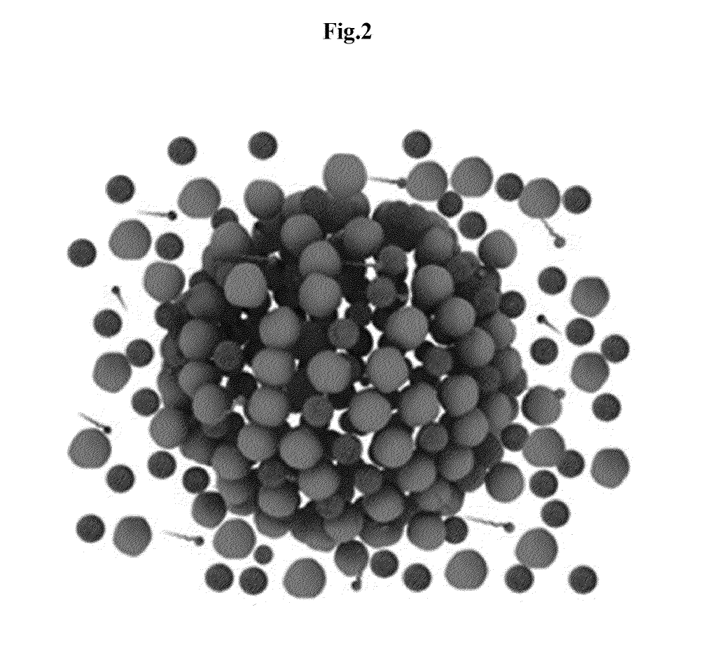

FIG. 1 is a process flowchart showing a method for preparing nanoporous photo catalysts having a high specific surface area and the high crystallinity according to an embodiment of the present invention, and FIG. 2 is a schematic view to explain sol-gel reaction.

Referring to FIG. 1, the method for preparing nanoporous photocatalysts having a high specific surface area and the high crystallinity includes a raw material mixing and sol-gel reaction step (step S110), a maturing step (step S120), a filtering/washing step (step S130), a primary drying step (step S140), an ultrasonification step (step S150), and a secondary drying step (step S160).

Raw Material and Sol-Gel Reaction

In the raw material mixing and sol-gel reaction step (step S110), a titanium precursor and a surfactant are mixed with a first solvent and the mixture is subject to sol-gel reaction. In this case, the first solvent may include water, alcohol, or the like. The sol-gel reaction may be performed at a room temperature. The room temperature may be varied according to used conditions. For example, the room temperature may be in the range of 1° C. to 40° C.

Meanwhile, referring to FIG. 2, the sol-gel reaction refers to a reaction in which metal alkoxide is subject to hydrolysis and condensation to be in a sol state, and then, if a predetermined time is elapsed, a complete condensation reaction is proceeded, so that the metal alkoxide becomes in the gel state in which a networking structure is not formed any more.

In other words, according to the sol-gel reaction, the surfactant is self-assembled in an aqueous solution to form micelles. In this case, the micelles are combined with titanium species to form a cooperative assembly while forming nanopores. Accordingly, titanium nanoporous framework having wormhole-like pores is synthesized. The titanium nanoporous framework is in the amorphous state.

Meanwhile, referring to FIG. 1, a titanium precursor may include titanium n-butoxide, titanium isopropoxide, and titanium chloride.

The surfactant may include cationic surfactant.

In this case, cationic surfactant may include cetyltrimethyl ammonium bromide satisfying chemical formula 1, or may include cetyltrimethyl ammonium chloride satisfying chemical formula 2.

CH₃(CH₂)nN⁺(CH₃)₃Br⁻ Chemical 1

CH₃(CH₂)nN⁺(CH₃)₃Cl⁻ Chemical 2

Preferably, the surfactant having n=10 to 18 in chemical formulas 1 and 2 is used. If n exceeds 18, the length of the hydrophobic tail is excessively lengthened, so that the surfactant may not be easily dissolved in the first solvent.

In this case, the molar ratio of the titanium precursor and the surfactant may be in the range of 3:0.01 to 3:1. If the molar ratio of the titanium precursor and the surfactant is less than 3:0.01, since an amount of added surfactant is insufficient, nanopores may not be formed. In contrast, if the molar ratio of the titanium precursor and the surfactant exceeds 3:1, only the preparation cost may be increased without the effect resulting from the addition of the surfactant.

Meanwhile, the molarity of the surfactant is preferably in the range of about 0.05M to about 2M. If the molarity of the surfactant is less than 0.05M, since the molarity is low, the nanopores may not be formed. In contrast, if the molarity of the surfactant exceeds 2M, effects are not made any more, but only the preparation cost may be increased.

Maturing

In the maturing step (step S120), the reactant, which has been subject sol-gel reaction, is matured for 15 hours to 25 hours. In this case, the maturing may be performed at a room temperature. The room temperature may be varied according to used environments. For example, the room temperature may be suggested in the range of about 1° C. to 40° C.

In this case, if the maturing time is less than 15 hours, the maturing effect may not be made sufficiently. In contrast, if the maturing time exceeds 25 hours, although crystallinity may be improved, the productivity may be degraded due to the excessive maturing time.

Filtering/Washing

Washing is performed after the matured reactant has been filtered in the filtering/washing step (step S130).

In the filtering/washing step (step S130), after the matured reactant has been subject to pressure reduction filtering, the reactant is washed by using distilled water. In this case, the washing process is preferably repeated at least 3 times.

Primary Drying

In the primary drying step (step S140), the washed reactant is primarily dried so that titanium dioxide is obtained. In this case, the primary drying is preferably vacuum-dried at the temperature of about 10° C. to 40° C. for 10 hours to 20 hours.

If the primary drying temperature is less than 10° C. or the primary drying time is less than 10 hours, the crystallinity of the reactant may be degraded. In contrast, if the primary drying temperature exceeds the temperature of 40° C. or the primary drying time exceeds 20 hours, the crystallinity of the reactant may be improved, but the specific surface area may be reduced.

Ultrasonification

In the ultrasonification step (step S150), after titanium dioxide sediments obtained through the primary drying step (step S140) are mixed with the second solvent, the mixture is subject to the ultrasonification.

In this case, the ultrasonification may be performed through a scanning scheme in the state that ultrasonic horn is dipped in the reaction vessel filled with the mixed solution. In addition, the second solvent may include water or alcohol.

The ultrasonification is performed in order to increase the crystallinity for nanopores of the amorphous framework because the titanium dioxide having wormhole-like pores formed through sol-gel reaction has nanoporous framework. According to the present invention, if the ultrasonification is performed, the nanopores having the amorphous framework are changed to nanopores having the crystalline framework. In detail, when the reactant filled in the reaction bath is bubble-collapsed through the ultrasonification, the reactant is subject to the extreme conditions, such as the local temperature of 5000K, the local pressure of 1000 bar, and the heating/cooling ratio of 10¹⁰K/s. For this reason, the crystalline property of the reactant may be improved and the chemical reactivity may be significantly increased on the reactant surface.

In the present step, according to the ultrasonification, high-intensity ultrasounds representing a frequency of 15 KHz to 25 KHz and output power of about 95 W to 110 W are preferably applied for 10 minutes to 60 minutes.

According to the experimental result, the diffraction peak of the anatase phase of TiO₂ is appeared from the ultrasonification time of at least 10 minutes, and the crystallinity may be continuously increased from 10 minutes.

In this case, if the ultrasonic output power is less than 95 W or the ultrasonification time is less than 10 minutes, the specific surface area may be significantly increased, but the crystallinity may not be improved. In contrast, if the ultrasound output power exceeds 110 W or the ultrasonification time exceeds 60 minutes, the crystallinity is improved, but the target specific surface area may not be ensured.

For example, before the ultrasonification is performed, the specific surface area of the reactant is about 700 m²/g. However, if the ultrasonification is performed for 10 minutes, the specific surface area of the reactant becomes about 600 m²/g. If the ultrasonification is performed for 40 minutes, the specific surface area of the reactant is reduced to about 400 m²/g.

Accordingly, when the ultrasound output power and the ultrasonification time may be suitably adjusted in the above range, the nanoporous photocatalysts capable of satisfying the high specific surface area and the high crystallinity can be prepared.

According to the present invention, when high-intensity ultrasound is applied, the reactant may have the bicrystalline phase of the anatase and brookite as well as a single crystalline phase of anatase. The bicrystalline phase may represent superior characteristics in terms of photo oxidation effect.

Secondary Drying

In the secondary drying step (step S160), the mixed solution, that has been subject to ultrasonification, is secondarily dried at a temperature of about 10° C. to 40° C., so that the titanium dioxide photocatalyst particles can be obtained. If the secondary drying temperature is less than 10° C., the excessive low drying temperature is represented, so that the reactant may not be dried sufficiently. In contrast, if the secondary drying temperature exceeds a temperature of about 4° C., the preparation coat may be increased. In addition, the specific surface area may be reduced due to the excessive drying.

As described above, the nanoporous photocatalysts having a high specific surface area and a high crystallinity according to the embodiment of the present invention can be prepared.

The nanoporous photocatalysts having the high specific surface area and the high crystallinity prepared in the step S110 to S160 have a plurality of wormhole-like nanopores having an average diameter of 1 nm to 3 nm, and a micro-framework of the nanoporous photocatalysts represents the single crystalline phase of anatase or the bicrystalline phase of the anatase and brookite. In addition, the nanoporous photocatalysts have a specific surface area of 350 m²/g to 650 m²/g.

Therefore, the nanoporous photocatalysts having the high specific surface area and the high crystallinity represent superior photo oxidation power for the organic matters due to the wormhole-like nanopores.

### Embodiment

Hereinafter, the structure and operation of the present invention will be described in detail with reference to the exemplary embodiments of the present invention. The following exemplary embodiments are illustrative purpose only and the present invention is not limited thereto.

Description about known functions and structures, which can be anticipated by those skilled in the art, will be omitted.

### 1. Specimen Preparation

### Embodiment 1

Titanium n-butoxide (97%) of Aldrich was used as a titanium precursor, and cetyltrimethyl ammonium bromide of Aldrich was used as a surfactant.

Titanium n-butoxide and cetyltrimethyl ammonium bromide (CTAB) solution having a carbon number of 11 in a carbon chain were mixed with each other by a strong mechanical stirrer for 5 minutes, subject to sol-gel reaction at a temperature of 25° C., and matured at a temperature of 17° C. for 20 hours.

Thereafter, the matured reactant was subject to the pressure reduction filtering, washed 3 times by using distilled water, and dried in a vacuum state at a temperature of 35° C. for 12 hours.

Thereafter, the titanium dioxide sediments were mixed with distilled water, and ultrasonification was performed with respect to the mixed solution at a frequency of 25 KHz under output power of 100 W for 60 minutes. Then, the titanium dioxide sediments were dried in the vacuum state at a temperature of 35° C. for 15 hours, so that the nanoporous photocatalysts were obtained.

### Embodiment 2

Nanoporous photocatalyst particles were obtained in the same manner as that of Embodiment 1 except that cetyltrimethyl ammonium bromide (CTAB) having a carbon number of 13 in a carbon chain was used, and ultrasonification was performed at a frequency of 20 KHz under the output power of 110 W for 10 minutes.

### Embodiment 3

Nanoporous photocatalyst particles were obtained in the same manner as that of Embodiment 1 except that cetyltrimethyl ammonium bromide (CTAB) having a carbon number of 15 in a carbon chain was used.

### Embodiment 4

Nanoporous photocatalyst particles were obtained in the same manner as that of Embodiment 1 except that cetyltrimethyl ammonium bromide (CTAB) having a carbon number of 17 in a carbon chain was used.

### Comparative Example 1

Nanoporous photocatalyst particles were obtained in the same manner as that of embodiment 1 except that the ultrasonification was performed at a frequency of 15 KHz under the output power of 95 W for 5 minutes.

### Comparative Example 2

In comparative example 2, 3 g of titanium nanopowder and 150 g of 10M sodium hydroxide solution were sufficiently mixed, and hydrothermal synthesis reaction was performed with respect to the mixture at a temperature of about 120° C. for 24 hours. The reactant was washed by 150 g of 0.1M HCL for 10 minutes in order to remove sodium cations (Na⁺) intercalated into the titanium layer. Created titanium sediments were filtered under the reduced pressure while the titanium sediments were being washed twice by using distilled water. Then, the sediments were dried for 24 hours in a dry oven at a temperature of 60° C., so that carbon titanium having a nano structure could be obtained.

### Comparative Example 3

P25 TiO₂, which has been extensively used as photocatalyst and available from Degussa Company, was prepared.

### 2 Estimation of Physical Property

Table 1 shows property estimation for specimens according to embodiments 1 to 4 and comparative examples 1 to 3.

TABLE 1

| | Specific surface | Nanoporous average |
|---|---|---|
| Classification | area (m2/g) | diameter (nm) |
| Target values | 350~650 | 1~3 |
| Embodiment 1 | 610 | 2 |
| Embodiment 2 | 550 | 2 |
| Embodiment 3 | 500 | 2 |
| Embodiment 4 | 500 | 2 |
| Comparative example 1 | 450 | 2 |
| Comparative example 2 | 100 | 5 |
| Comparative example 3 | 50 | NA |

Referring to table 1, the specimens prepared according to embodiments 1 to 4 satisfied all target conditions of the specific surface area of 350 m²/g to 650 m²/g and a nanoporous average diameter of 1 nm to 3 nm.

In contrast, when comparing with embodiment 1, in the case of comparative example 1, in which the ultrasound treatment energy was out of the range suggested according to the present invention, the specific surface area approximated a target value. In addition, although the nanopore had an average diameter of 2 nm, the desirable crystallinity was not obtained.

In addition, in the case of specimens prepared according to comparative example 2, although the specific surface area satisfied the target value, but the average diameter of the nanopore was out of the target value.

In the case of the specimens prepared according to the comparative example 3, the specific surface area not only had a value of 50 m²/g, which is significantly less than the target value, but also the nanopores are hardly formed.

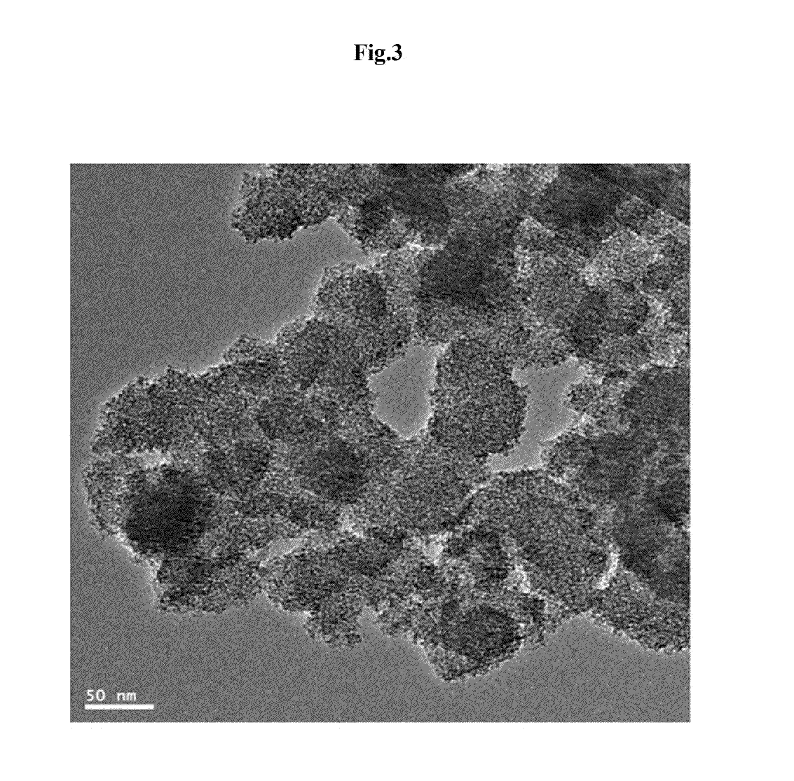

FIG. 3 is a photograph of the specimens prepared according to embodiment 1 taken by a high-resolution electron microscope.

Referring to FIG. 3, the specimen prepared according to the embodiment had wormhole-like pores having an average diameter of about 2 nm.

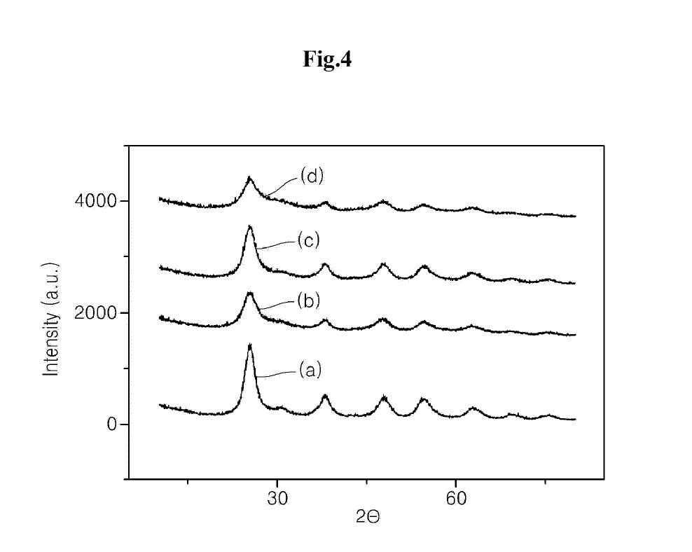

FIG. 4 is a graph showing an X-ray diffraction pattern for specimens prepared according to embodiments 1 to 4.

Referring to FIG. 4, as shown in the result of the X-ray diffraction pattern, although the specimens (a), (b), (c), and (d) had crystalline peaks different from each other, the specimens (a), (b), (c), and (d), which had been prepared according to embodiments 1 to 4, represented superior crystallinity. In this case, the specimens (a), (b), (c), and (d) had the single crystalline phase of anatase or the bicrystalline phase of the anatase and brookite regardless of a carbon number in a carbon chain of the surfactant.

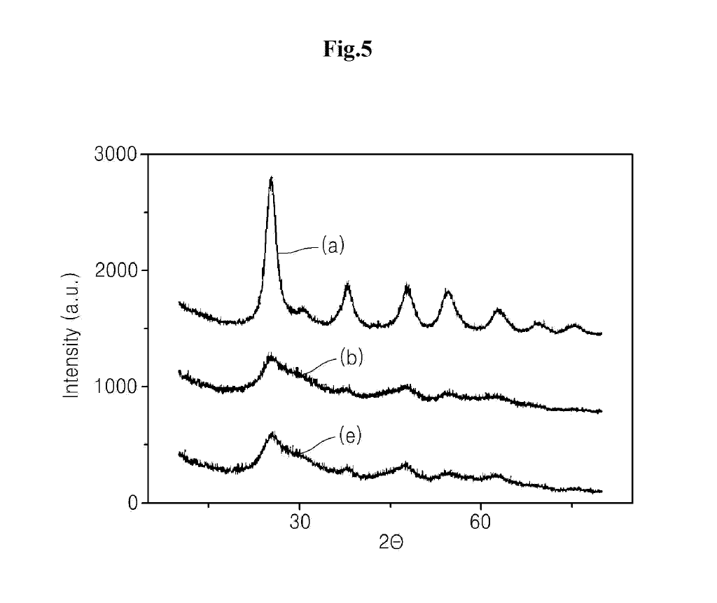

FIG. 5 is a graph showing an X-ray diffraction pattern for specimens prepared according to embodiments 1 to 2 and comparative example 1.

Referring to FIG. 5, the specimens (a) and (b), which had been prepared according to embodiments 1 and 2, had crystallinity superior to that of the specimen (e) which had been prepared according to comparative example 1. As recognized from the experimental results, as ultrasonification time is lengthened, crystallinity could be improved.

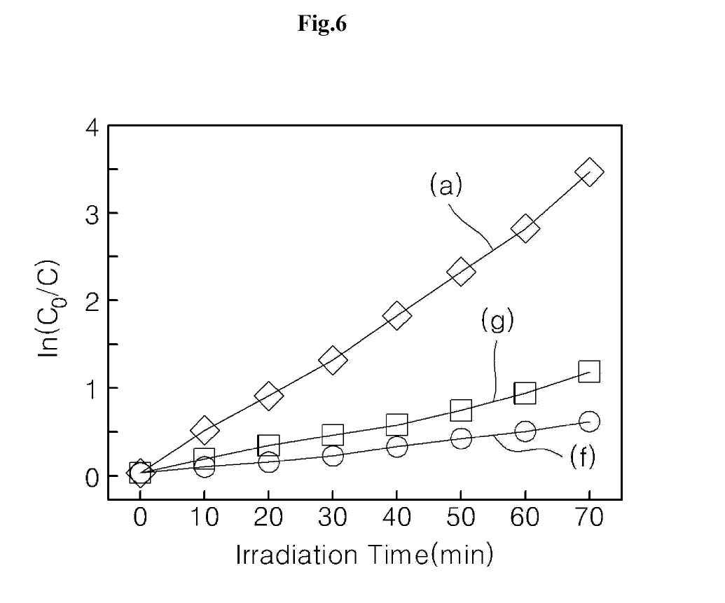

FIG. 6 is a graph showing the experimental results of organic matter photo oxidation for specimens prepared according to embodiment 1, and the comparative examples 2 and 3. In this case, according to the organic matter photo oxidation experiments, the specimens prepared according to embodiments 1 to 3 and comparative examples 1 and 2 were stored in a sealed test tube together with 1 mg/L of Reactive Black 5 and 0.1 g/L of Rhodamine B for 40 hours.

Referring to FIG. 6, according to the experimental results of the organic matter photo oxidation, the specimen (a) prepared according to embodiment 1 had the superior purification ability as compared with that of specimens (f) and (g) prepared according to comparative examples 2 and 3. This is because the specimen (a) prepared according to the embodiment 1 not only had wormhole-like nanopores, but also had the specific surface area of 350˜650 m2/g, which represent superior crystallinity.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A nanoporous photocatalyst comprising a plurality of nanopores having an average diameter of about 1 nm to about 3 nm, wherein a micro-framework of the nanoporous photocatalyst has a single crystalline phase of anatase or a bicrystalline phase of anatase and brookite, and a specific surface area of the nanoporous photocatalyst is in a range of about 350 m²/g to about 650 m²/g.

2. A method for preparing a nanoporous photocatalyst having a high specific surface area and high crystallinity, the method comprising:
(a) mixing a titanium precursor and a surfactant with a first solvent and performing sol-gel reaction for a mixture;
(b) maturing a reactant, which has been subject to the sol-gel reaction, for 15 hours to 25 hours;
(c) washing the matured reactant after filtering the matured reactant;
(d) obtaining titanium dioxide sediments by primarily drying the reactant at a temperature of about 10° C. to about 40° C.;
(e) mixing the titanium dioxide sediments with a second solvent, and performing ultrasonification with respect to a mixture for 10 minutes to 60 minutes; and
(f) obtaining titanium dioxide photocatalyst particles by secondarily drying the mixture, which has been subject to the ultrasonification, at a temperature of about 10° C. to about 40° C.

3. The method of claim 2, wherein the surfactant includes cetyltrimethyl ammonium bromide satisfying n=10 to 18 in chemical formula 1 or cetyltrimethyl ammonium chloride satisfying n=10 to 18 in chemical formula 2,
CH₃(CH₂)nN⁺(CH₃)₃Br⁻ Chemical 1
CH₃(CH₂)nN⁺(CH₃)₃Cl⁻. Chemical 2

4. The method of claim 2, wherein, in step (e), the ultrasonification is performed at a frequency of about 15 KHz to about 25 KHz under output power of about 95 W to about 110 W.
